(19) United States
(12) Patent Application Publication
(10) Pub. No.: US 2010/0328661 A1
(43) Pub. Date: Dec. 30, 2010

(54) APPARATUS AND METHOD FOR LASER INDUCED BREAKDOWN SPECTROSCOPY USING A MULTIBAND SENSOR

(75) Inventors: Sébastien Blais-Ouellette, Laval (CA); Daniel Gagnon, Chambly (CA); Simon Lessard, Saint-Basile-Le-Grand (CA)

Correspondence Address: Photon etc., 5795 De Gaspe Avenue, #222, Montreal, QC, H2S 2X3, CA

(73) Assignee: PHOTON ETC, INC., Montréal, QC (CA)

(21) Appl. No.: 12/918,376

(22) PCT Filed: Feb. 20, 2009
(86) PCT No.: PCT/CA2009/000193

§ 371 Date: Aug. 19, 2010

Related U.S. Application Data
(60) Provisional application No. 61/064,226, filed on Feb. 22, 2008.

(51) Int. Cl. G01J 3/28

(52) U.S. Cl. 356/328

(57) ABSTRACT

A laser induced breakdown spectroscopy (LIBS) system uses discrete optical filters for isolated predetermined spectral components from plasma light created by ablation of a sample. Independent detection elements may be used for detecting the magnitude for each spectral component. A first spectral component may include a characteristic wavelength of the sample, while a second spectral component may be a portion of a background continuum. The filters may include volume Bragg gratings and the detectors may be photodiodes. A detector that detects plasma light remaining after the isolation of the predetermined spectral components may be used together with a signal acquisition controller to precisely control the initiation and termination of signal acquisition from each of the detection elements. The system may also have optics including a collimating lens through which passes both the initial plasma light and the isolated spectral components.

### FIELD OF THE INVENTION

The present invention relates generally to spectral analysis, and more particularly to spectral analysis of a sample using laser induced breakdown spectroscopy.

### BACKGROUND OF THE INVENTION

Laser induced breakdown spectroscopy (LIBS) is used to characterize materials. It involves using laser ablation of a material to create a plasma, and spectroscopic technology to observe and analyze the plasma light spectrum and thus determine the constituents of the material.

Many current spectroscopic techniques use a grating to disperse the plasma light and a CCD or detector array to capture and analyze the plasma light spectrum. An example of such an arrangement is shown in FIG. 1, in which a Q-switched pulsed laser 11 is used to ablate the surface of a sample 13, thereby creating a plasma. Optical energy from the plasma is collected by collector optics 15 and coupled into optical fiber 17. At the opposite end of the optical fiber, the optical energy is output toward a spectrometer 19 which, in this example, includes a diffractive grating 21 and a detection element 23. The diffractive grating disperses the light from the fiber according to wavelength, and the spectrally dispersed light is detected by the detection element 23 which, in this case, is a charge-coupled device (CCD) element. The output of the detection element 23 is directed to a computer 25 which is used in performing the spectral analysis.

LIBS may be used to determine a wide optical spectrum from the plasma of an ablated sample. However, if the constituents of a material to be analyzed are known, LIBS may be used just to evaluate the relative abundance of each constituent of the material, or to monitor the presence of impurities therein. In such cases, only one or a few spectral lines may be of interest, along with an appropriate background continuum evaluation.

Shown in FIG. 2 is a graph showing a spectral output signal at three different times following laser ablation of a sample in a conventional LIBS system. At 0.25 μs, the magnitude of the background signal is very high, as is the magnitude of two characteristic peaks at 279.55 nm and 280.27 nm. At this time, the peak at 285.213 nm is still obscured by the background signal. At 5 μs, the background signal is significantly reduced, and the first two peaks are more pronounced, while the peak at 285.213 nm is beginning to emerge from the background. Finally, at 35 μs, the two first peaks are diminished along with the background signal, while the peak at 285.213 has not decayed as quickly, and is therefore more pronounced relative to the background radiation. Thus, it can be seen that there are different time frames following the laser ablation at which the different wavelength peaks have a better signal to noise ratio relative to the background signal.

### SUMMARY OF THE INVENTION

In accordance with the present invention, a laser-induced breakdown spectroscopy system is provided that uses multiband sensing for analyzing light emitted from the plasma of an ablated sample material. The system has a first discrete optical filter that receives at least a portion of the plasma light and isolates from it a first predetermined narrowband spectral component. The first spectral component is directed to a first optical detector that generates an output signal indicative of its magnitude. A second discrete optical filter, distinct from the first optical filter, also receives at least a portion of the plasma light, and isolates from it a second predetermined narrowband spectral component. The second spectral component is directed to a second optical detector that generates an output signal indicative of its magnitude.

In an exemplary embodiment of the invention, the optical filters include volume Bragg gratings and the optical detectors are photodiodes. The optical filters may be reflective, with the plasma light being directed along an optical axis where the first and second optical filters are positioned. The plasma light is incident on the first optical filter, and the portion of the light that is not isolated and reflected by the first optical filter is subsequently incident on the second optical filter. The first optical filter may be positioned so as to reflect the first spectral component in a first predetermined direction while transmitting the remaining light. Similarly, the second optical filter reflects the second spectral component in a second predetermined direction and transmits the remaining plasma light.

In one embodiment, the first spectral component may include a characteristic wavelength of a constituent material of the sample, while the second spectral component includes a portion of a background continuum of the plasma light. Alternatively, each of the first and second spectral components may include a different characteristic wavelength indicative of the same or of a different respective constituent material of the sample. One or more additional discrete optical filters may also be used, each of which isolates a different, predetermined narrowband spectral component from the plasma light. These additional isolated spectral components can each be directed to its own optical detector, each of which generates an output signal indicative of the magnitude of its associated spectral component. It is also possible that the optical detectors are each part of a single detector array. The optical filters may also be integrated on a common physical substrate.

A third optical detector may also be included that receives a remaining portion of the plasma light after the isolation of the first and the second spectral components. The detection of this remaining plasma light may be used for optical triggering of the system. This trigger optical detector may operate in conjunction with a signal acquisition controller that is responsive to the output signal of the detector. In particular, the controller may initiate signal acquisition from the optical detectors detecting the isolated spectral components in response to a change in the trigger output signal, such as a change indicating initial receipt of plasma light following sample ablation. The controller may also terminate a signal acquisition from each optical signal detector a respective predetermined time after the change in the output signal of the trigger optical detector. The controller may include an integrator associated with each of the optical signal detectors that integrates the output signal of its respective detector during the time between the initiation and the termination of the signal acquisition. The controller may also include a field-programmable gate array as well as other components.

Various additional optical components may also be used with the system. Collimating optics are used to collect and collimate the plasma light and to direct the plasma light toward the first optical filter. These collimating optics may include a principal collimating lens via which the plasma light is directed to the first optical filter. The system may also be arranged such that the isolated first spectral component also passes through the principal collimating lens, as does the isolated second spectral component. In this way, the principal collimating lens may focus the light from the optical filters onto their respective optical detectors. In such an arrangement, the system may be contained in a compact space while still allowing the necessary distances between optical components. Each of the optical detectors may also be connected to a common electrical circuit board of the system, allowing the electrical connections to be made all via the same electrical substrate.

The invention includes a method of analyzing a plasma light obtained from laser induced breakdown spectroscopy. An exemplary embodiment of this method includes the steps of isolating a first narrowband spectral component from at least a portion of the plasma light using a first discrete optical filter, and isolating a second narrowband spectral component from at least a portion of the remainder of the plasma light using a second discrete optical filter. The second narrowband spectral component may be a separate signal, or may be representative of background noise. The first and second narrowband spectral components are then detected and the resulting detection signals analyzed as appropriate to the application. This method may be extended to any number of narrowband spectral components. Triggering of the signal acquisition for the narrowband spectral components may be accomplished with a trigger optical detector that provides an output indicative of the initial receipt of plasma light following sample ablation. The method may also include precisely controlling an integration for each optical detector that detects a narrowband spectral component.

### BRIEF DESCRIPTION OF THE DRAWINGS

FIG. 1 is a prior art schematic representation of a conventional LIBS material analysis system.

FIG. 2 is an exemplary spectral graph of a LIBS spectral analysis.

FIG. 3 is a schematic representation of a multiband sensor system according to a first embodiment of the invention, showing its use with a LIBS system.

FIG. 4 is a schematic representation of a multiband sensor system according to a second embodiment of the invention, showing its use with a LIBS system.

FIG. 5 is a schematic representation of a system similar to that of FIG. 4 in which additional spectral components are isolated and detected.

FIG. 6 is a schematic perspective view of a multiband sensor system according to an embodiment of the present invention in which the system is arranged in a compact configuration.

FIG. 7 is a schematic top view of the system shown in FIG. 6.

FIG. 8 is a schematic side view of a portion of the system shown in FIG. 6.

FIG. 9 is a schematic top view of a system that is similar to that of FIG. 6 but that is configured for the isolation and detection of additional spectral components of interest

FIG. 10 is a schematic side view of a portion of the system shown in FIG. 9.

FIG. 11 is a schematic diagram showing a control system for the processing of optical detector output signals of the present invention.

### DETAILED DESCRIPTION

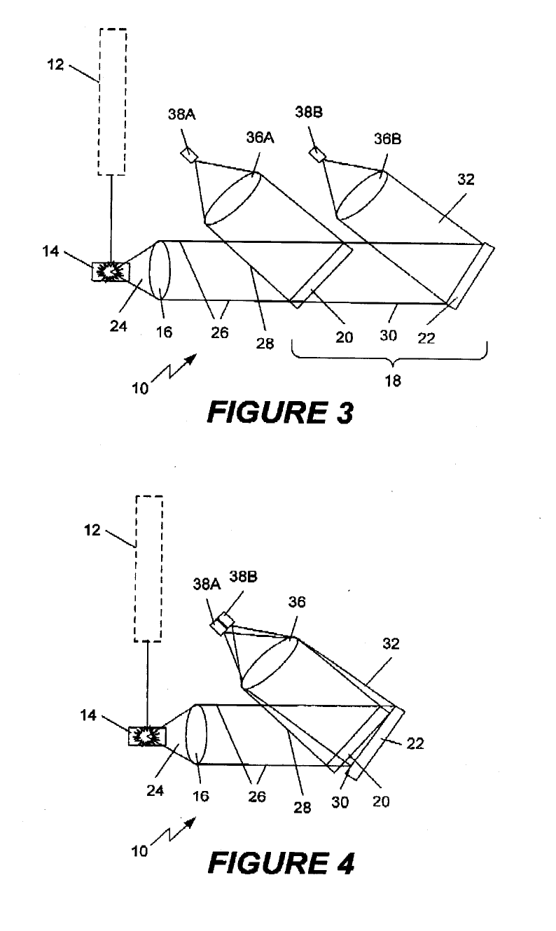

In the following description, the term “light” is used to refer to all electromagnetic radiation, including visible light. Furthermore, the term “optical” is used to qualify all electromagnetic radiation, including light in the visible spectrum. Shown in FIG. 3 is a multiband sensor system 10 for use with laser induced breakdown spectroscopy (LIBS). A laser 12 is used to ablate material from the surface of a sample 14 and create a plasma. The multiband sensor system is then used to collect and analyze the light 24 of the plasma.

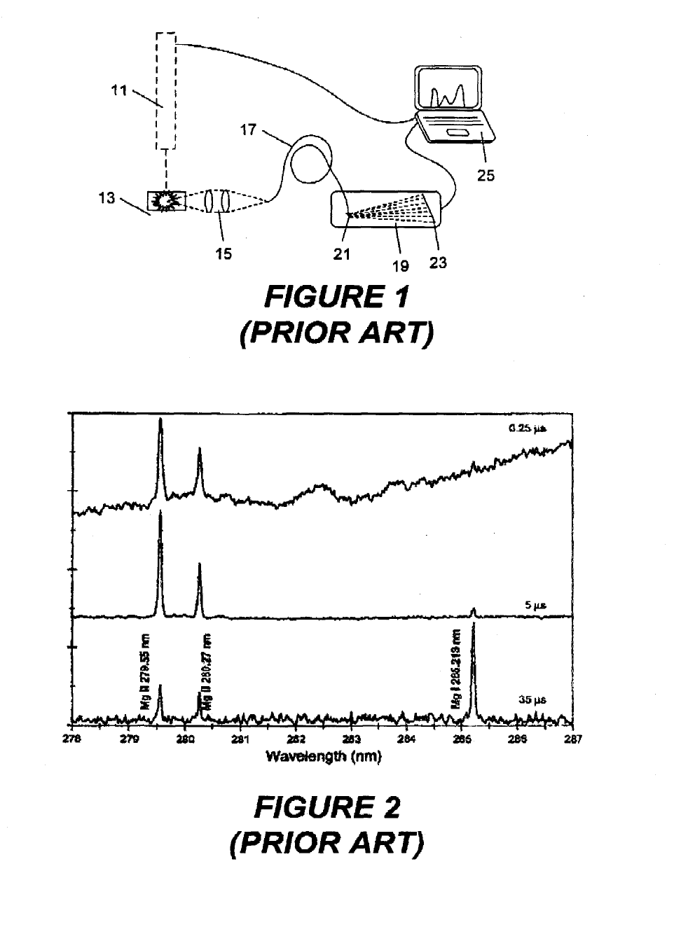

Because the spectrum of the plasma light 24 is characteristic of the material under study, analysis thereof provides information on the constituents of the material of the sample 14 (as shown, for example, in FIG. 2). The plasma light 24 is collected and collimated by the collimating optics 16 of the multiband sensor system 10. The collimating optics 16 may be embodied by any appropriate optical component or assembly of components and may simply include a lens or series of lenses. While the collimating optics 16 is shown adjacent to the point of ablation of the sample 14, those skilled in the art will understand that there need not be such proximity between these components, and that the plasma light 24 may be collected and transported to the collimating optics in other ways, such as through the use of an optical fiber, as is shown in the prior art system of FIG. 1. Similar optical collection means may be used with all of the embodiments of the present invention disclosed herein.

In the system of FIG. 3, the collimated plasma light 24 impinges upon a first filtering component 20. The first filtering component 20 isolates from the plasma light a first narrowband spectral component 28 that is preferably centered on the wavelength of a plasma emission line under study. In this embodiment, the first filtering component 20 is a volume Bragg grating and the first narrowband spectral component 28 is filtered by reflection of the light by the grating. Those skilled in the art will recognize that filters using refraction or diffraction may also be used to provide the desired isolation of the first spectral component, given an appropriate orientation of the system components. The first narrowband spectral component 28 is focused using appropriate focusing optics 36A onto a detector 38A where its magnitude is detected either continuously, or at one or more specific times following the ablation of the sample, and then recorded for subsequent analysis. The focusing optics 36A may include any appropriate lens or combination of lenses.

The remaining wavelengths 30 of the collimated plasma light 26 that are not filtered out by the first filtering component 20 are transmitted therethrough. The transmitted wavelengths 30 impinge upon a second filtering component 22. At the second filtering component, a second narrowband spectral component 32, which is centered on a wavelength proximate to the plasma emission line under study, and which may be a portion of the background continuum (where no significant spectral response is expected), is next filtered out. The second filtering component 22 is also a volume Bragg grating in this embodiment, and the second narrowband spectral component 32 may be filtered by reflection, refraction or diffraction of the light by the grating. The second narrow wavelength band 32 may also be focused using appropriate focusing optics 36B onto a detector 38B where its magnitude is detected and recorded for subsequent analysis. As with the focusing optics 36A, the focusing optics 36B may include any appropriate lens or combination of lenses.

The embodiment of FIG. 3 makes use of discrete filtering components 20, 22, focusing optics 36A, 36B, and separate detectors 38A, 38B. However, it is possible to consolidate some of these components and to make the system more compact, if so desired. For example, in the embodiment of FIG. 4, the filtering components 20, 22 are located directly adjacent to each other, and the respective spectral components that they filter out of the plasma light pass through the same space, although each filtering component provides the filtered light with a different direction. In this embodiment, the focusing optics for both beams are consolidated into focusing optics 36 that, due to the different respective transmission directions of the spectral components, focus each onto a different respective detector 38A, 38B. In this arrangement, the two detectors may therefore reside directly adjacent to one another, which may prove advantageous for providing them with appropriate electrical connections.

For most applications of the present invention, the filtering components 20, 22 need not be identical nor used in the same manner. For example, to increase the signal-to-noise ratio, the bandwidth of the second filtering component 22 may be greater than that of the first filtering component 20. In another embodiment, which would be particularly appropriate in a compact configuration as is shown in FIG. 4, the first and second filtering components 20 and 22 may be combined into a single integral optical component, such as a single doped glass substrate in which are inscribed multiple volume Bragg gratings. Similarly, each of the detectors 38A and 38B (shown in FIGS. 3 and 4) may be a single element detector, such as a photodiode or avalanche photodiode, or a detector array, such as a CCD array. Alternatively, the two detectors may be combined into a single detector array. In a configuration such as that shown in FIG. 4 (i.e., where the two detectors are located adjacent to each other), a single detector array could easily detect the two different spectral components on different regions of its detection surface.

The embodiments of FIGS. 3 and 4 are shown with two filtering components each, and each is therefore appropriate for detecting two separate narrowband wavelength ranges. As mentioned above, the use of two filtering components may be convenient for the detection of a single wavelength band of interest, in that one of the filtering components could isolate the wavelength band of interest, while the other could isolate a narrow wavelength band indicative of the background in a nearby wavelength range. Such a background signal may then be used in determining a relative magnitude of the signal in the wavelength band of interest. However, those skilled in the art will recognize that the second filtering component could instead detect a signal in another wavelength band of interest, that is. a band containing a spectral component indicative of a particular sample constituent. In such a system, an analysis might involve a comparative measurement of the two signal bands of interest without reference to a background signal. As discussed below, a system may also use more than two detection bands some or none of which may be background signals.

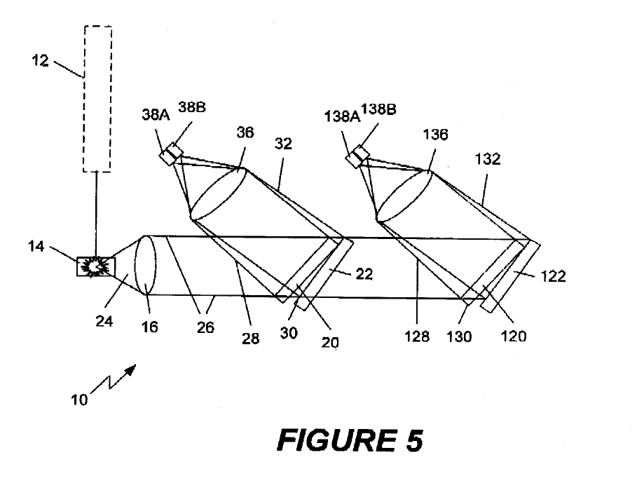

Within the context of the present invention, it is also possible to extract multiple plasma emission lines each with a corresponding background signal for observing multiple spectral lines simultaneously. For such a case, an embodiment of the invention using multiple pairs of filtering components may be provided. Each pair of filtering components (e.g., like the pair of filtering components shown in FIGS. 3 and 4) would filter out and direct to a different respective detection element a wavelength band of interest and a background signal from a nearby wavelength band. Since the background signal tends to vary over the entire spectral range of the plasma light, using an adjacent background spectral band for each wavelength band of interest provides a more accurate measurement of each signal relative to its respective background. An example of such as system is shown schematically in FIG. 5.

The system of FIG. 5 is similar to that of FIG. 4, but uses two pairs of filtering components instead of one. Those skilled in the art will understand that this could be extended to as many more filtering component pairs as desired. The components of the first filtering pair use the same reference numerals as in FIG. 4. and have the same functionality. The components of the second filtering pair also have the same functionality, but for different wavelength bands of interest. The plasma light that is not reflected by the filtering component pair 20, 22 is transmitted to the filtering pair 120, 122, where the additional wavelength bands are reflected. One of these additional wavelength bands may be a narrow band centered on a different wavelength of interest such as might correspond to a constituent of the ablated sample. The other additional band may correspond to a section of the background continuum in a wavelength range close to the band of the other filtering component of the pair. The narrowband spectral component 128 that is reflected by grating 120 is focused by focusing optics 136 and detected by detector 138B. Similarly, the narrowband spectral component 132 that is reflected by grating 122 is focused by focusing optics 136 and detected by detector 138A.

Advantageously, in accordance with another embodiment of the multiband sensor system, the multiple pairs of filtering components may be combined into a single integral component. A single integral optical component that can reflect, refract or diffract multiple spectral lines at different angles may take the form of a single doped glass substrate in which are inscribed multiple volume Bragg gratings with various angular orientations. In the case where multiple spectral lines (wavelengths or narrow wavelength bands) are focused side-by-side or in an array of points, a detector array, such as a CMOS array, may be preferable for detecting and recording the filtered wavelength bands.

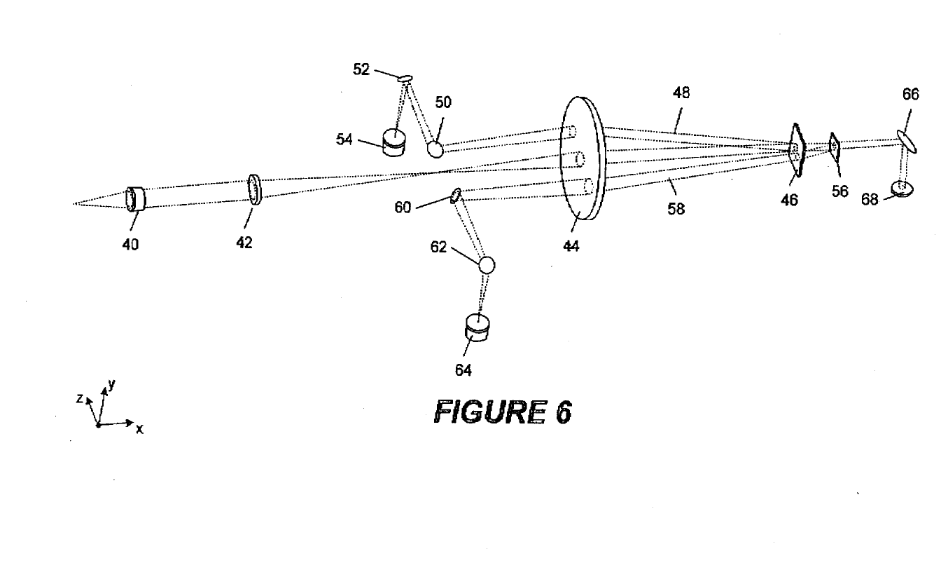

Shown in FIG. 6 is a schematic view of an alternative embodiment of the present invention that uses a particular optical arrangement. In this embodiment, the plasma light from a sample ablation is collected from the sample location, or from an interim light transmission means (such as an optical fiber), by collimating lens 40. The collimated light is then refocused by focusing optics 42, which may be a single lens. The focused light from the lens 42 is collimated by large collimating lens 44. Notably, the light from the lens 42 occupies only a central region of the large lens 44. The plasma light is then directed from lens 44 toward a first volume Bragg grating 46, which reflects a narrowband spectral component of interest 48 back toward the large lens 44. The angle of redirection of the spectral component 48 is such that it is incident upon a portion of the lens 44 outside of the region upon which the light from the lens 42 is incident, such that these two different light paths do not overlap. The spectral component 48 is refocused by the lens 44, and reflected laterally by mirror 50 in the “z-direction” as indicated in the figure. Mirror 52 is then used to again reflect the light, this time in the (negative) “y-direction,” where it is thereafter detected by photodiode 54. While not shown in the figure, those skilled in the art will understand that additional lenses or other optical components may be included here, such as an additional lens for more tightly focusing the spectral component onto the photodiode. Such additional components may allow for an optimization of the optical design of the system.

The light that is not reflected by grating 46 passes through to grating 56, which is configured to reflect a spectral component different than that of grating 46 and in a different direction. The spectral component 58 that is reflected by grating 56 is directed to another region of the large lens 44 that is not occupied by either the original light from lens 42 or by the spectral component 48. In a manner symmetrical to that of spectral component 48, the spectral component 58 is focused toward mirror 60, which redirects it in the negative z-direction toward mirror 62 which again redirects it in the (negative) y-direction toward photodiode 64. The light that is not reflected by either the grating 46 or the grating 56 passes through both to a mirror 66, which reflects it in the (negative) y-direction toward an optical detector 68. This detected signal may be used for to provide information regarding background intensity or, as discussed in more detail below, to establish the timing for the optimal detection of the spectral components by the detectors 54, 64.

The system of FIG. 6 is advantageous in that it is compact, due to the various reflections of the different spectral components, and uses a minimum number of relatively inexpensive components. The use of focusing lenses allows the volume Bragg gratings to be relatively small (and therefore less expensive) and, as with the earlier embodiments, the use of photodiodes for detecting the filtered spectral components allows the cost of detection to be significantly less. The use of mirrors to reflect the signals to be detected all along the same direction (i.e., the negative y-direction shown in the figure), allows all of the detection components to be located on a single electrical circuit board, simplifying the electrical design of the system. Moreover, the use of a single lens 44 for both collimating the light from the lens 42 and focusing the respective spectral components 48, 58 reduces the required number of system components. Those skilled in the art may also notice that the grating 46 is shown as being significantly larger than grating 56 in the present embodiment. This is to ensure that the entire reflected beam from grating 56 passes through grating 46, as any overlapping of the beam with the edge of grating 46 would result in distortion due to diffraction. Alternatively, grating 46 could be made smaller and positioned so as to avoid completely any interaction with the beam reflected from grating 56.

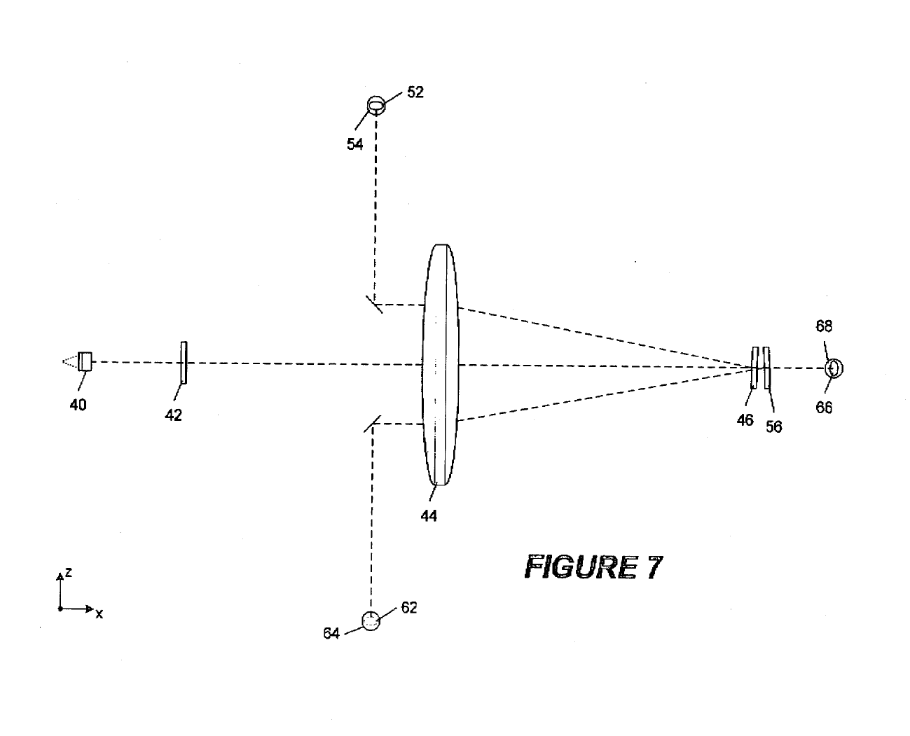

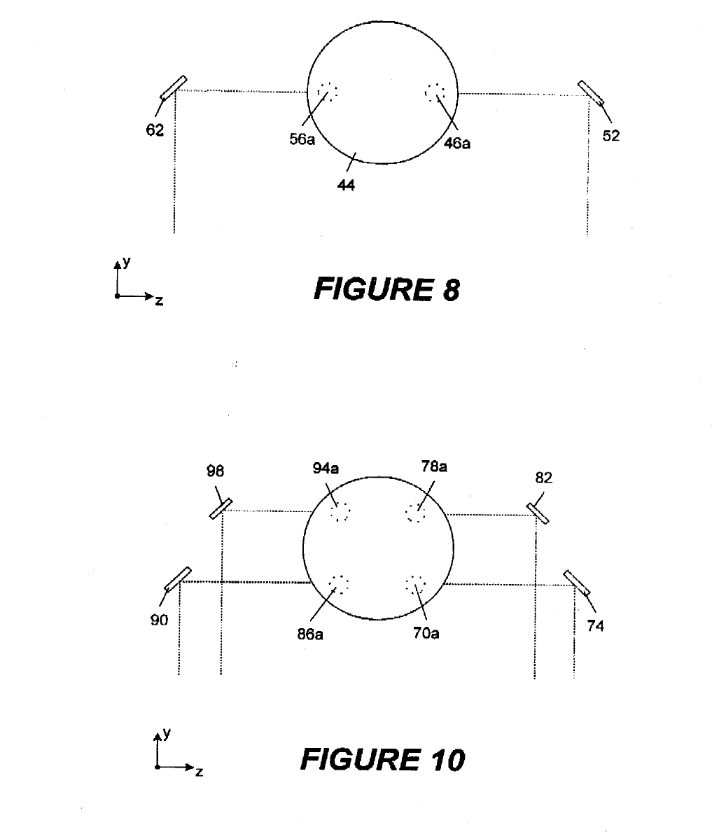

FIG. 7 is a schematic top view of the system shown in FIG. 6 that aides in understanding the geometrical arrangement of the components therein. In this figure, dashed lines are used to trace the center of each of the light beams. As shown, the gratings 46 and 56 each reflect their respective spectral component in a direction that allows it to be incident on a different portion of the lens 44. As these portions are focused by the lens 44 onto mirrors 50 and 60, respectively, they are redirected laterally toward respective mirrors 52 and 62 and, eventually, to photodetectors 54 and 64. This lateral redirection allows the photodetectors to have a good separation from one another, which may be advantageous for the layout of an electrical circuit board to which they may be attached. This arrangement of mirrors and detectors can also be seen in the schematic view of FIG. 8, which is taken along the x-y plane, that is, looking toward the lens 44 from the position of grating 46 in FIG. 6. Broken lines are used to indicate regions 46a and 56a on the lens 44 upon which the spectral components reflected by gratings 46 and 56 are incident, respectively. As this figure is intended to depict just the geometrical arrangement of lens 44 and mirrors 52, 62, the other components of the system are not shown. As can be seen, the refocused light from the lens 44 is redirected in the z-direction and y-direction to eventually reach the respective photodetectors.

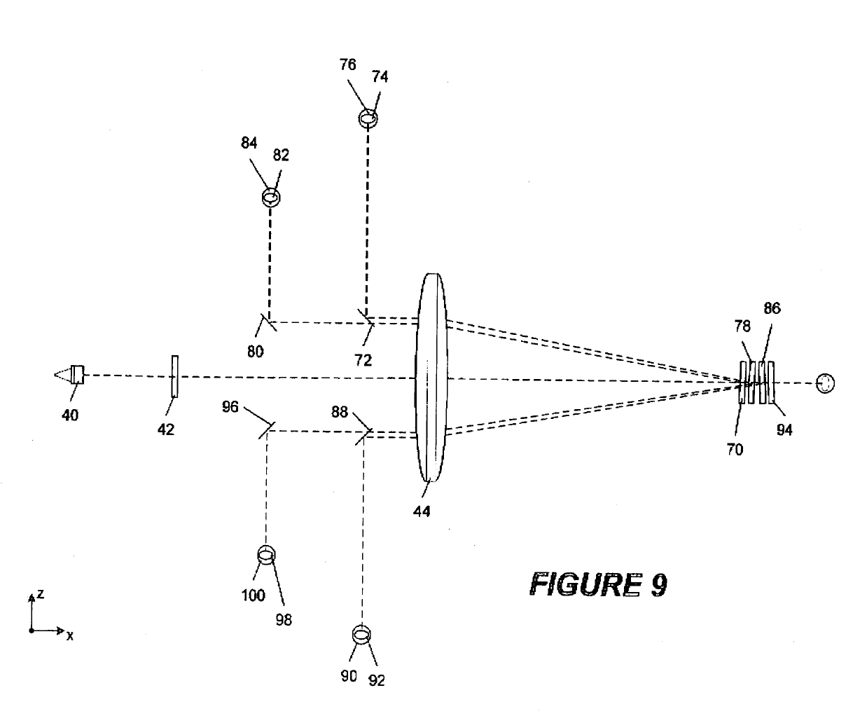

The embodiment of FIGS. 6-8 may be extended to the filtering and detection of more than two spectral components. By using additional gratings, each with a different angular tilt relative to a center axis of transmission from the lens 44, the different spectral bands reflected by the gratings may be refocused by different regions of the lens 44. FIG. 9 is a schematic top view (similar to the view of FIG. 7) of such a system showing a possible geometrical relationship between the gratings, mirrors and lenses. In this arrangement, a first grating 70 may reflect a first narrowband spectral component that is refocused by a first region of lens 44 toward a mirror 72 that reflects it toward a mirror 74 that, in turn, reflects it to a photodetector 76. Each of the other narrowband spectral components intersects a different respective region of the lens 44, and each has a similar set of mirrors and photodetector but with different geometric positioning. Thus, a narrowband spectral component reflected by grating 78 is refocused to mirror 80, mirror 82 and finally photodetector 84, a narrowband spectral component reflected by grating 86 is refocused to mirror 88, mirror 90 and photodetector 92, and a narrowband spectral component reflected by grating 94 is refocused to mirror 96, mirror 98 and finally to mirror 100.

In this embodiment, the geometric arrangement is such that the photodetectors are offset from each other in both the x-direction and the z-direction, although they are preferably all mounted to the same electrical circuit board (and therefore in the same position relative to the y-direction). Those skilled in the art will understand that, in the top view of FIG. 9, the dashed lines represent a center axis of each of the light beams for the purpose of understanding the geometrical relationship of one possible system configuration, and that these light paths may be varied without changing the basic functionality of the system. The embodiment of FIG. 9 may also be understood from FIG. 10 that, like FIG. 8, is a view taken in the y-z plane. This view shows, in broken lines, regions 70a, 78a, 86a and 94a of the lens 44 where spectral components reflected by gratings 70, 78, 86 and 94 are incident, respectively. Since this figure is intended to show just the geometrical relationship between the lens 44 and the mirrors 74, 82, 90 and 98, the other components of the system are not shown.

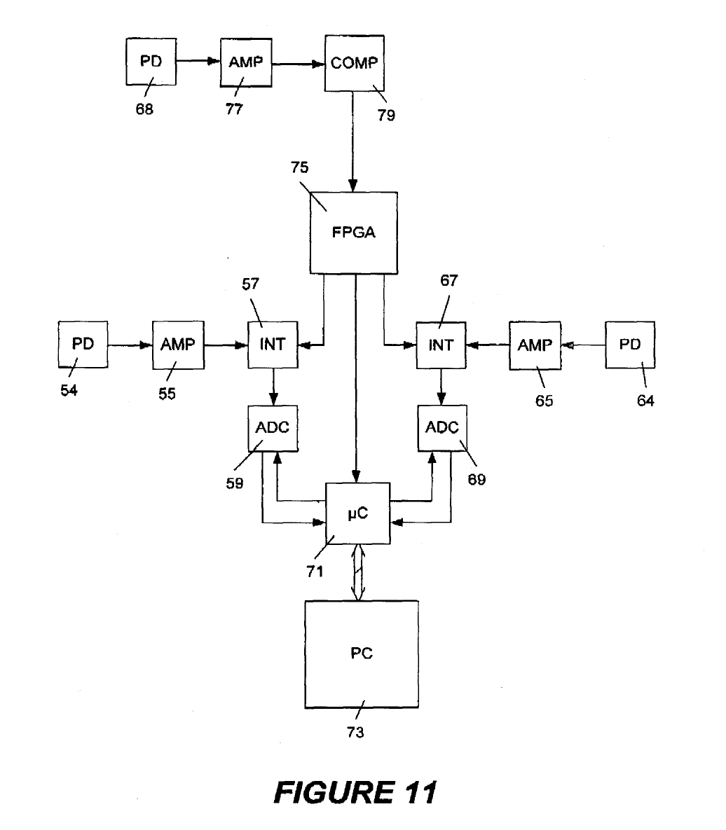

In the systems shown in FIG. 6-10, the optical detector 68 receives all of the light not isolated by the optical filters of the system, and may be used for precisely controlling signal acquisition. In the present embodiment, the optical detector is a photodiode, the output of which is used as a trigger for determining the start of the respective time periods during which a signal will be acquired from the optical detectors that detect the spectral components isolated by the optical filters. FIG. 11 is a schematic diagram showing how this signal control is effected, In this figure, only two isolated spectral channels are discussed (as is the case with FIG. 6), but this manner of detection is applicable to the other embodiments herein, with any number of different detected spectral components.

The detectors 54 and 64 of FIG. 6, which are photodiodes in the present embodiment, are labelled “PD” in FIG. 11, and are identified using the same reference numerals as in FIG. 6. The output of each photodiode is directed to a respective amplifier 55, 65 that amplifies its magnitude. Each of these electrical signals is directed to a respective integrator 57, 67 that integrates the (amplified) output of its corresponding photodiode over a particular time period. The proper selection and control of this time period has a significant effect on the quality of the data output. As shown in FIG. 2, different spectral components of the plasma light have magnitudes that change differently over time with respect to a background continuum. Thus, the precise starting and stopping of each of the integrators 57, 67 of FIG. 11 can be used to provide high signal quality.

The integrators 57, 67 function as charge accumulators and, therefore, provide analog electrical output signals. These analog signals are subsequently digitized by analog-to-digital converters 59, 69, respectively, which are controlled by microcontroller 71. The microcontroller 71 receives the digitized output values of the ADCs, and ultimately provides these values to a computer 73 for processing. The precise timing of the signal integration, however, is controlled by a field-programmable gate array (FPGA) 75.

FPGA 75 is a semiconductor device that may be programmed with user-defined logic to perform a variety of different tasks. In the present embodiment, the FPGA is configured to provide the “start” and “stop” commands to the integrators 57, 67 that define their respective periods of signal acquisition. Because the FPGA 75 is capable of fast processing times, it allows for the integration periods to be precisely controlled. In addition, the input trigger to the FPGA, which it uses to determine when to start and stop the integration periods, is based on the signal detection of photodiode 68.

The electrical signal output of photodiode 68 is amplified by an amplifier 77 to increase the signal magnitude. This amplified signal is provided to a comparator 79 which maintains a floating threshold relative to level of the input signal. Since the output of photodiode 68 may vary with ambient light and other system factors, this threshold allows an output of the comparator to be based on a fast change in the magnitude of the photodiode output, while ignoring slow changes in baseline magnitude. When such a change occurs, as is the case when the plasma light from sample ablation first reaches the photodiode 68, the comparator outputs a pulse to the FPGA indicating that the sampling phase has begun. Depending on the specific parameters of system and the sample under investigation, the FPGA then applies an appropriate delay for the triggering of each of the respective integrators 57, 67, For each of the integrators, following a predetermined time after the start of the integration cycle, a second signal is sent by the FPGA 75 instructing the integrator to stop accumulating charge. The FPGA also communicates with the microcontroller 71 to indicate that the signal acquisition is complete. The microcontroller 71 can then instruct each ADC 59, 69 to read and digitize the output of its respective integrator 57, 67 and to return the digitized values. These values are then forwarded to computer 73 for subsequent processing.

The system of FIG. 11, corresponding essentially to FIG. 6, detects only two different spectral components. However, those skilled in the art will understand that the system is extendible to the detection of additional spectral components in the same manner. It will also be understood that the specific timing for signal acquisition may vary from one photodiode to another. For example, if the two spectral components being detected with the system of FIG. 6 A corresponded, respectively, to a narrowband wavelength range containing a wavelength of interest, and a different range corresponding to a background continuum, it might be desirable to have both photodiode signals integrated over the same time period. Alternatively, if the two signals corresponded to two different wavelengths of interest (e.g., indicative of two different sample constituents), it might be preferable to integrate the two photodiode signals over different time periods to best maximize the signal-to-noise ratio for each. Notably, the system may also make use of triggering from an outside signal, as is done in the prior art, but it is the accuracy of using detection of a portion of the plasma light as a trigger with fast processing components that permits a high degree of precision in controlling the signal acquisition periods.

The present multiband sensor system is versatile in that it can be easily miniaturized to adaptively fit with most LIBS systems. It is also versatile in that the first and second wavelength bands may be adjustably selected by angularly adjusting the first and second filtering components respectively. The use of multiband detection may allow for the use of less expensive components, and may provide a more compact design. In addition, the first and second filtering components may be separate optical components, or may be combined into a single optical component. The multiple pairs of optical components may also be combined into a single integral component. Different types of filters may also be used, and the filtering of the first and second spectral components may be accomplished using reflection, refraction or diffraction. The detectors may be of a number of different types, including photodiodes or avalanche photodiodes. The first and second detection elements may each be single element detectors. In another variation, the first and second detectors may each be a different respective detector array or, as mentioned above, the first detector and the second detector may be combined into a single detector array.

While the invention has been shown and described with reference to a preferred embodiment thereof, those skilled in the art will understand that various changes in form and detail may be made herein without departing from the spirit and scope of the invention as defined by the appended claims.

What is claimed is:

1. A laser-induced breakdown spectroscopy system for analyzing light emitted from the plasma of an ablated sample material, the system comprising:
a first discrete optical filter that receives at least a portion of said plasma light and that isolates a first predetermined narrowband spectral component therefrom;
a first optical detector to which the first spectral component is directed, the first detector generating an output signal indicative of the magnitude of the first spectral component;
a second discrete optical filter distinct from the first optical filter, the second filter receiving at least a portion of said plasma light and isolating a second predetermined narrowband spectral component therefrom; and
a second optical detector to which the second spectral component is directed, the second detector generating an output signal indicative of the magnitude of the second spectral component, wherein the first and second optical detectors are part of a single detector array.

2. A system according to claim 1 wherein at least one of the first optical filter and the second optical filter comprises a volume Bragg grating.

3. A system according to claim 1 wherein the single detector array comprises a photodiode.

4. A system according to claim 1 wherein said plasma light is directed along an optical axis, and wherein the first and second optical filters are positioned along said axis such that the plasma light is incident on the first optical filter, and the plasma light that is not isolated by the first optical filter is subsequently incident on the second optical filter.

5. A system according to claim 4 wherein the first optical filter reflects the first spectral component along a first predetermined direction and transmits the remaining plasma light.

6. A system according to claim 1 wherein the first spectral component comprises a characteristic wavelength of a constituent material of the sample, and the second spectral component comprises a portion of a background continuum of the plasma light.

7. A system according to claim 1 further comprising collimating optics that collect and collimate the plasma light.

8. A system according to claim 1 further comprising a principal collimating lens that directs the plasma light toward the first optical filter, wherein at least one of the first and second isolated spectral components passes through said principal collimating lens.

9. A system according to claim 1 further comprising a third optical detector to which a remaining portion of the plasma light is directed after the isolation of the first and second spectral components by the first and second optical filters, respectively, the third optical detector generating an output signal indicative of the magnitude of the remaining plasma light portion.

10. A system according to claim 9 further comprising a signal acquisition controller that is responsive to the output signal of the third optical detector, the controller initiating a signal acquisition from the first optical detector in response to a change in the output signal of the third optical detector.

11. A system according to claim 10 wherein the controller initiates a signal acquisition from the first optical detector a predetermined time after a change in the output signal of the third optical detector indicates an initial receipt of plasma light following sample ablation.

12. A system according to claim 11 wherein the controller terminates a signal acquisition from the first optical detector a predetermined time after said change in the output signal of the third optical detector.

13. A system according to claim 12 wherein the controller comprises an integrator that integrates the output signal from the first optical detector during the time between the initiation and the termination of the signal acquisition.

14. A system according to claim 10 wherein the signal acquisition controller initiates a signal acquisition from the second optical detector in response to said change in the output signal of the third optical detector.

15. A system according to claim 1 further comprising one or more additional discrete optical filters each of which isolates a different, predetermined narrowband spectral component from the plasma light, and one or more additional optical detectors each associated with a different one of the isolated narrowband spectral components and each generating an output signal indicative of the magnitude its associated spectral component.

16. (canceled)

17. A system according to claim 1 wherein the first and second discrete optical filters are both integrated on a common physical substrate.

18. A laser-induced breakdown spectroscopy system for analyzing light emitted from the plasma of an ablated sample material, the system comprising:
a plurality of discrete optical filters each of which receives at least a portion of said plasma light and that isolates a different respective predetermined narrowband spectral component therefrom;
a plurality of optical signal detectors each receiving a different one of the respective narrowband spectral components and generating an output signal indicative of the magnitude its respective spectral component;
a trigger optical detector that receives at least a portion of the plasma light and generates a trigger output signal indicative thereof; and
a signal acquisition controller that is responsive to the trigger output signal, the controller initiating signal acquisition from the optical signal detectors in response to a change in the magnitude of the trigger output signal.

19. A system according to claim 18 wherein the controller initiates a signal acquisition from each optical signal detector a respective predetermined time after a change in the output signal of the trigger optical detector indicates an initial receipt of plasma light following sample ablation.

20. A system according to claim 19 wherein the controller terminates a signal acquisition from each optical signal detector a respective predetermined time after said change in the output signal of the trigger optical detector.

21. A system according to claim 20 wherein the controller comprises an integrator that integrates the output signal from each optical signal detector during the time between the initiation and the termination of the signal acquisition for that detector.

22. A method of performing a laser-induced breakdown spectroscopic analysis in which light emitted from the plasma of an ablated sample material is analyzed, the method comprising:
receiving at least a portion of said plasma light with a first discrete optical filter that isolates a first predetermined narrowband spectral component therefrom;
directing the first spectral component to a first optical detector that generates an output signal indicative of the magnitude of the first spectral component;
receiving at least a portion of said plasma light with a second discrete optical filter distinct from the first optical filter, the second filter isolating a second predetermined narrowband spectral component therefrom; and
directing the second spectral component to a second optical detector that generates an output signal indicative of the magnitude of the second spectral component, wherein the first and second optical detectors are part of a single detector array.

23. A method according to claim 22 wherein at least one of the first optical filter and the second optical filter comprises a volume Bragg grating.

24. A method according to claim 22 wherein at least one of the first optical detector and the second optical detector comprises a photodiode.

25. A method according to claim 22 further comprising directing said plasma light along a first optical axis along which the first and second optical filters are positioned such that the plasma light is incident upon the first optical filter, and the plasma light that is not isolated by the first optical filter is subsequently incident on the second optical filter.

26. A method according to claim 25 wherein the first optical filter reflects the first spectral component along a predetermined direction and transmits the remaining plasma light.

27. A method according to claim 22 wherein the first spectral component comprises a characteristic wavelength of a constituent material of the sample, and the second spectral component comprises a portion of a background continuum of the plasma light.

28. A method according to claim 22 further comprising receiving a remaining portion of the plasma light with a third optical detector after the isolation of the first and second spectral components by the first and second optical filters, respectively, the third optical detector generating an output signal indicative of the magnitude of the remaining plasma light portion.

29. A method according to claim 28 further comprising initiating, with a signal acquisition controller that is responsive to the output signal of the third optical detector, a signal acquisition from the first optical detector in response to a change in the output signal of the third optical detector.

30. A method according to claim 29 wherein the controller initiates a signal acquisition from the first optical detector a predetermined time after a change in the output signal of the third optical detector indicates an initial receipt of plasma light following sample ablation.

31. (canceled)

32. (canceled)

33. (canceled)

34. (canceled)

35. A laser-induced breakdown spectroscopy system for analyzing light emitted from the plasma of an ablated sample material, the system comprising:
a primary lens that receives and collimates focused light originating from the plasma;
a first discrete reflective Bragg grating that receives at least a portion of said collimated plasma light and that isolates and reflects a first predetermined narrowband spectral component therefrom, the first spectral component encountering the primary lens and being focused thereby;
a first optical detector to which the focused first spectral component is directed from the primary lens, the first detector generating an output signal indicative of the magnitude of the first spectral component;
a second discrete reflective Bragg grating distinct from the first grating, the second grating receiving at least a portion of said collimated plasma light and isolating and reflecting a second predetermined narrowband spectral component therefrom, the second spectral component encountering the primary lens and being focused thereby; and
a second optical detector to which the focused second spectral component is directed from the primary lens, the second detector generating an output signal indicative of the magnitude of the second spectral component.

36. A system according to claim 35 wherein said collimated plasma light is directed along an optical axis, and wherein the first and second optical filters are positioned along said axis such that the plasma light is incident on the first optical filter, and the plasma light that is not isolated by the first optical filter is subsequently incident on the second optical filter.

37. A system according to claim 35 wherein the first spectral component comprises a characteristic wavelength of a constituent material of the sample, and the second spectral component comprises a portion of a background continuum of the plasma light.

38. A system according to claim 35 further comprising a third optical detector to which a remaining portion of the plasma light is directed after the isolation of the first and second spectral components by the first and second optical filters, respectively, the third optical detector generating an output signal indicative of the magnitude of the remaining plasma light portion.

39. A system according to claim 38 further comprising a signal acquisition controller that is responsive to the output signal of the third optical detector, the controller initiating a signal acquisition from the first optical detector in response to a change in the output signal of the third optical detector.

40. A system according to claim 35 wherein the first and second optical detectors are part of a single detector array.
